(19) United States
(12) Patent Application Publication
(10) Pub. No.: US 2017/0080510 A1
(43) Pub. Date: Mar. 23, 2017

(54) CONTACT TIP AND COUPLING ASSEMBLY OF A WELDING TORCH

(71) Applicant: ILLINOIS TOOL WORKS INC., Glenview, IL (US)

(72) Inventors: Robert Joseph Centner, Frankfort, IL (US); Robert Lloyd Warning, Cedar Lake, IL (US)

(21) Appl. No.: 15/253,378

(22) Filed: Aug. 31, 2016

Related U.S. Application Data
(60) Provisional application No. 62/220,696, filed on Sep. 18, 2015.

(51) Int. Cl. B23K 9/16; B23P 19/00; B23K 9/29; B23K 9/28; B23K 9/32

(52) U.S. Cl. CPC B23K 9/164; B23K 9/287; B23K 9/325; B23K 9/291; B23P 19/00

(57) ABSTRACT

A welding torch system includes a nozzle, a contact tip retainer assembly, and a diffuser assembly. The diffuser assembly couples to the neck of a welding torch. Additionally, the welding torch system includes a contact tip axially secured between the contact tip retainer assembly and the diffuser assembly. Further, the nozzle axially secures the contact tip retainer assembly and the contact tip to the diffuser assembly.

### CROSS REFERENCE TO RELATED APPLICATION

This application is a Non-provisional U.S. Patent Application of U.S. Provisional Application No. 62/220,696, entitled “Contact Tip and Coupling Assembly of a Welding Torch,” filed Sep. 18, 2015, which is hereby incorporated by reference in its entirety for all purposes.

### BACKGROUND

The present disclosure relates generally to welding systems and, more particularly, to securement of contact tips in welding torches of welding systems.

Welding is a process that has increasingly become ubiquitous in various industries and applications. Contact tips used in metal inert gas (MIG) welding processes are frequently replaced during operation of a welding gun. Many contact tips are threaded into the welding gun. However, threadless contact tip designs also have been used. For example, threadless contact tip designs having a cam surface have been used. The cam surface is adapted to bind the contact tip against a stationary protrusion when the contact tip is rotated. Additionally, a threadless contact tip may be secured between a gas diffuser and a contact tip retaining component that is permanently affixed within a welding nozzle assembly.

There are a number of disadvantages associated with existing threadless contact tip designs. For example, variations in an axial distance between the contact tip and the front, exterior face of the nozzle, known as a tip-nozzle recess, occur with existing threadless contact tip designs. A consistent tip-recess distance may be useful in certain welding applications, especially robotic welding systems. Additionally, welding nozzle assemblies with permanently affixed contact tip retaining components may accumulate welding “spatter” upon surfaces of the contact tip retaining components. As the retaining components are permanently affixed to the welding nozzle assembly, it may be difficult to remove the accumulated spatter from the surface of the contact tip retaining components.

There exists a benefit in using a welding gun that utilizes a threadless contact tip design. Additionally, there is a benefit in using a welding gun that enables a contact tip to be installed and removed without the use of tools. Further, there exists a benefit in using a threadless contact tip design that produces a consistent tip-recess distance. Furthermore, there exists a benefit in using a threadless contact tip design that utilizes a nozzle without a permanently affixed contact tip retaining component.

Therefore, it may be advantageous to provide a mechanism that simplifies replacement and securement of components within welding systems that are frequently replaced. The present subject matter provides a mechanism for replacement and securement of contact tips within a welding system without the use of tools.

### BRIEF DESCRIPTION

Certain embodiments commensurate in scope with the originally claimed subject matter are summarized below. These embodiments are not intended to limit the scope of the claimed subject matter, but rather these embodiments are intended only to provide a brief summary of possible forms of the subject matter. Indeed, the subject matter may encompass a variety of forms that may be similar to or different from the embodiments set forth below.

In a first embodiment, a welding torch system includes a nozzle, a contact tip retainer assembly, and a diffuser assembly. The diffuser assembly couples to the neck of a welding torch. Additionally, the welding torch system includes a contact tip axially secured between the contact tip retainer assembly and the diffuser assembly. Further, the nozzle axially secures the contact tip retainer assembly and the contact tip to the diffuser assembly.

In another embodiment, a welding torch system includes a contact tip assembly. The contact tip assembly includes a nozzle, a contact tip retainer assembly, a diffuser assembly, and a contact tip. The contact tip is axially secured between the contact tip retainer assembly and the diffuser assembly in response to securement of the nozzle relative to the diffuser assembly. Additionally, the contact tip comprises a first portion, a second portion, and a third portion. Further, the second portion includes a second average diameter that is greater than a first average diameter of the first portion and a third average diameter of the third portion.

In another embodiment, a method includes applying a first axial force on a contact tip toward a diffuser assembly of a welding torch to position a first cylindrical portion of the contact tip within the diffuser assembly. Further, the method includes applying a second axial force on a contact tip retainer assembly toward the diffuser assembly of the welding torch such that the contact tip retainer assembly is positioned at least partially radially around the contact tip. Additionally, the method includes securing a welding nozzle to the diffuser assembly to establish a secure coupling of the contact tip to the diffuser assembly.

In another embodiment, a contact tip includes a first portion that mounts without tools within a retention orifice of a diffuser assembly. Additionally, the contact tip includes a second portion that abuts a contact tip retainer assembly. Further, the contact tip includes a third portion that extends through an inner bore of a contact tip retainer assembly when the contact tip retainer assembly is installed over the third portion.

In another embodiment, a method includes applying a first axial force on a contact tip retainer assembly toward a welding nozzle of a welding torch to removably secure the contact tip retainer assembly within the welding nozzle. Additionally, the method includes applying a second axial force on a contact tip toward the contact tip retainer assembly within the welding nozzle such that the contact tip retainer assembly is positioned at least partially radially around the contact tip. Further, the method includes securing the welding nozzle to the diffuser assembly to establish a secure coupling of the contact tip to the diffuser assembly.

In another embodiment, a contact tip retainer assembly includes an electrically insulating portion that abuts a diffuser assembly of a welding torch. Additionally, the contact tip retainer assembly includes an electrically conductive portion including gas through ports. Further, the contact tip retainer assembly includes an inner bore that extends through a center portion of the electrically insulating portion and the electrically conductive portion. Furthermore, the electrically insulating portion and the electrically conductive portion at least partially receive a contact tip within the inner bore during a welding operation of the welding torch.

### DRAWINGS

These and other features, aspects, and advantages of the present disclosure will become better understood when the following detailed description is read with reference to the accompanying drawings in which like characters represent like parts throughout the drawings, wherein:

FIG. 1 is an embodiment of a metal inert gas (MIG) welding system with a power source and a wire feeder, in accordance with the present disclosure;

FIG. 2 is a side view of an embodiment of a welding torch of the MIG welding system of FIG. 1, in accordance with the present disclosure;

FIG. 3 is an exploded view of a portion of the welding torch of FIG. 2, in accordance with the present disclosure;

FIG. 4 is a cross-sectional illustration of the portion of the welding torch of FIG. 3, in accordance with the present disclosure;

FIG. 5 is a cross-sectional illustration of a magnified portion of the welding torch of FIG. 4, in accordance with the present disclosure;

FIG. 6 is a flow diagram of a method to install a contact tip within the welding torch, in accordance with the present disclosure;

FIG. 7 is a flow diagram of an additional method to install a contact tip within the welding torch, in accordance with the present disclosure;

FIG. 8 is a front perspective view of a design for a contact tip, in accordance with the present disclosure;

FIG. 9 is a rear perspective view of a design for the contact tip of FIG. 8, in accordance with the present disclosure;

FIG. 10 is a front view of a design for the contact tip of FIG. 8, in accordance with the present disclosure;

FIG. 11 is a rear view of a design for the contact tip of FIG. 8, in accordance with the present disclosure;

FIG. 12 is a first side view of a design for the contact tip of FIG. 8, in accordance with the present disclosure;

FIG. 13 is a second side view of a design for the contact tip of FIG. 8, in accordance with the present disclosure;

FIG. 14 is a top view of a design for the contact tip of FIG. 8, in accordance with the present disclosure;

FIG. 15 is a bottom view of a design for the contact tip of FIG. 8, in accordance with the present disclosure;

FIG. 16 is a cross-sectional cutaway view of a design for the contact tip of FIG. 8, in accordance with the present disclosure;

FIG. 17 is a front-side perspective view of a design for a contact tip retainer assembly, in accordance with the present disclosure;

FIG. 18 is a rear-side perspective view of a design for the contact tip retainer assembly of FIG. 17, in accordance with the present disclosure;

FIG. 19 is a front perspective view of a design for the contact tip retainer assembly of FIG. 17, in accordance with the present disclosure;

FIG. 20 is a rear perspective view of a design for the contact tip retainer assembly of FIG. 17, in accordance with the present disclosure;

FIG. 21 is a front view of a design for the contact tip retainer assembly of FIG. 17, in accordance with the present disclosure;

FIG. 22 is a rear view of a design for the contact tip retainer assembly of FIG. 17, in accordance with the present disclosure;

FIG. 23 is a first side view of a design for the contact tip retainer assembly of FIG. 17, in accordance with the present disclosure;

FIG. 24 is a second side view of a design for the contact tip retainer assembly of FIG. 17, in accordance with the present disclosure;

FIG. 25 is a top view of a design for the contact tip retainer assembly of FIG. 17, in accordance with the present disclosure;

FIG. 26 is a bottom view of a design for the contact tip retaining assembly of FIG. 17, in accordance with the present disclosure;

FIG. 27 is a cross-sectional cutaway view of a design for the contact tip retaining assembly of FIG. 17, in accordance with the present disclosure;

FIG. 28 is a front-side perspective view of a design for a welding nozzle, in accordance with the present disclosure;

FIG. 29 is a rear-side perspective view of a design for the welding nozzle of FIG. 28, in accordance with the present disclosure;

FIG. 30 is a front perspective view of a design for the welding nozzle of FIG. 28, in accordance with the present disclosure;

FIG. 31 is a rear perspective view of a design for the welding nozzle of FIG. 28, in accordance with the present disclosure;

FIG. 32 is a front view of a design for the welding nozzle of FIG. 28, in accordance with the present disclosure;

FIG. 33 is a rear view of a design for the welding nozzle of FIG. 28, in accordance with the present disclosure;

FIG. 34 is a first side view of a design for the welding nozzle of FIG. 28, in accordance with the present disclosure;

FIG. 35 is a second side view of a design for the welding nozzle of FIG. 28, in accordance with the present disclosure;

FIG. 36 is a top view of a design for the welding nozzle of FIG. 28, in accordance with the present disclosure;

FIG. 37 is a bottom view of a design for the welding nozzle of FIG. 28, in accordance with the present disclosure; and

FIG. 38 is a cross-sectional cutaway view of a design of the welding nozzle of FIG. 28, in accordance with the present disclosure.

### DETAILED DESCRIPTION

One or more embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

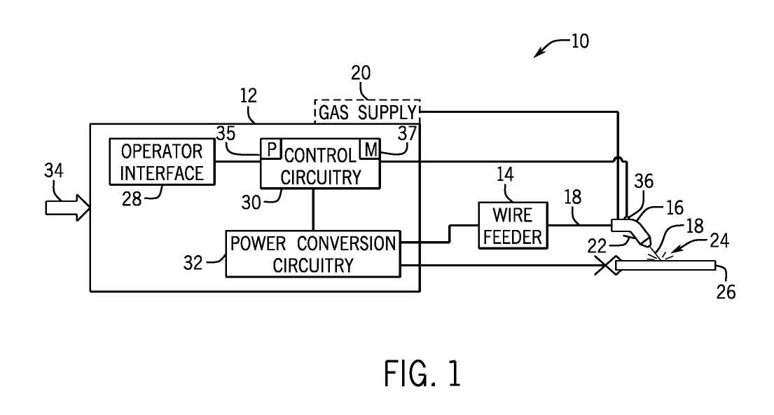

Turning now to the drawings, and referring first to FIG. 1, an exemplary welding system 10 is illustrated as including a power source 12 coupled to a wire feeder 14. In the illustrated embodiment, the power source 12 is separate from the wire feeder 14, such that the wire feeder 14 may be positioned at some distance from the power source 12 near a welding location. However, it should be understood that the wire feeder 14, in some implementations, may be integral with the power source 12. The power source 12 may supply weld power to a torch 16 through the wire feeder 14, or the power source 12 may supply weld power directly to the torch 16. The wire feeder 14 supplies a wire electrode 18 (e.g., solid wire, cored wire, coated wire) to the torch 16. A gas supply 20, which may be integral with or separate from the power source 12, supplies a gas (e.g., CO₂, argon) to the torch 16. An operator may engage a trigger 22 of the torch 16 to initiate an arc 24 between the electrode 18 and a work piece 26. In some embodiments, the welding system 10 may be triggered by an automation interface including, but not limited to, a programmable logic controller (PLC) or robot controller. The welding system 10 is designed to provide welding wire (e.g., electrode 18), weld power, and shielding gas to the welding torch 16. As will be appreciated by those skilled in the art, the welding torch 16 may be of many different types, and may facilitate use of various combinations of electrodes 18 and gases.

The welding system 10 may receive data settings from the operator via an operator interface 28 provided on the power source 12. The operator interface 28 may be incorporated into a faceplate of the power source 12, and may allow for selection of settings such as the weld process (e.g., stick, TIG, MIG), the type of electrode 18 to be used, voltage and current settings, transfer mode (e.g., short circuit, pulse, spray, pulse), and so forth. In particular, the welding system 10 allows for MIG welding (e.g., pulsed MIG welding) with electrodes 18 (e.g., welding wires) of various materials, such as steel or aluminum, to be channeled through the torch 16. The weld settings are communicated to control circuitry 30 within the power source 12.

The control circuitry 30 operates to control generation of welding power output that is applied to the electrode 18 by power conversion circuitry 32 for carrying out the desired welding operation. In some embodiments, the control circuitry 30 may be adapted to regulate a pulsed MIG welding regime that may have aspects of short circuit transfer and/or of spray transfer of molten metal from the welding wire to a molten weld pool of a progressing weld. Such transfer modes may be controlled during operation by adjusting operating parameters of current and voltage pulses for arcs 24 developed between the electrode 18 and the work piece 26.

The control circuitry 30 is coupled to the power conversion circuitry 32, which supplies the weld power (e.g., pulsed waveform) that is applied to the electrode 18 at the torch 16. The power conversion circuitry 32 is coupled to a source of electrical power, as indicated by arrow 34. The power applied to the power conversion circuitry 32 may originate in a power grid, although other sources of power may also be used, such as power generated by an engine-driven generator, batteries, fuel cells, or other alternative sources. Components of the power conversion circuitry 32 may include choppers, boost converters, buck converters, inverters, and so forth.

The control circuitry 30 controls the current and/or the voltage of the weld power supplied to the torch 16. The control circuitry 30 may monitor the current and/or voltage of the arc 24 based at least in part on one or more sensors 36 within the wire feeder 14 and/or the torch 16. In some embodiments, a processor 35 of the control circuitry 30 determines and/or controls operating parameters of the torch 16. The processor 35 determines and/or controls the operating parameters utilizing data (e.g., algorithms, instructions, operating points) stored in a memory 37. The data stored in the memory 37 may be received via the operator interface 28, a network connection, or preloaded prior to assembly of the control circuitry 30. Operation of the power source 12 may be controlled in one or more modes, such as a constant voltage (CV) regulation mode in which the control circuitry 30 controls the weld voltage to be substantially constant while varying the weld current during a welding operation. That is, the weld current may be based at least in part on the weld voltage. Additionally, or in the alternative, the power source 12 may be controlled in a current control mode in which the weld current is controlled independent of the weld voltage. In some embodiments, the power source 12 is controlled to operate in a constant current (CC) mode where the control circuitry 30 controls the weld current to be substantially constant while varying the weld voltage during a welding operation.

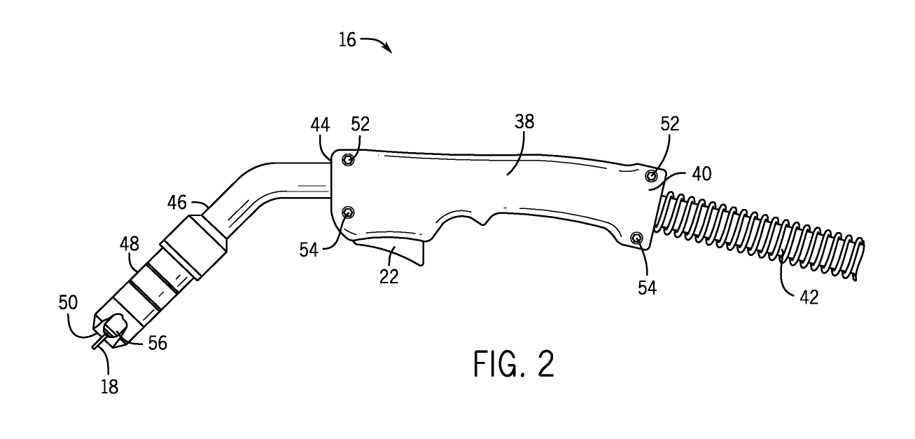

FIG. 2 illustrates an embodiment of the torch 16 of FIG. 1. As discussed in relation to FIG. 1, the torch 16 includes the trigger 22 for initiating a weld and supplying the electrode 18 to the weld. Specifically, in the illustrated embodiment, the trigger 22 is disposed on a handle 38. A welding operator holds the handle 38 when performing a weld. At a first end 40, the handle 38 is coupled to a cable 42 where welding consumables (e.g., the electrode 18, the shielding gas, and so forth) are supplied to the weld. Welding consumables generally travel through the handle 38 and exit at a second end 44, which is disposed on the handle 38 at an end opposite from the first end 40.

The torch 16 includes a neck 46 extending out of the second end 44 of the handle 38. As such, the neck 46 is coupled between the handle 38 and a welding nozzle 48. As should be noted, when the trigger 22 is pressed or actuated, welding wire (e.g., electrode 18) travels through the cable 42, the handle 38, the neck 46, and the welding nozzle 48, so that the welding wire extends out of an end 50 (i.e., torch tip) of the welding nozzle 48. Further, as illustrated in FIG. 2, in certain embodiments, the handle 38 is secured to the neck 46 via fasteners 52 and 54, and to the cable 42 via fasteners 52 and 54. The welding nozzle 48 is illustrated with a portion of the welding nozzle 48 removed to show the electrode 18 extending out of a contact tip 56 that is disposed within the welding nozzle 48. In operation, the contact tip 56 generally directs the electrode 18 (e.g., welding wire) toward a work piece 26, and the contact tip 56 conducts electrical current from the cable 42 to the electrode 18 via contact of the electrode 18 with the contact tip 56.

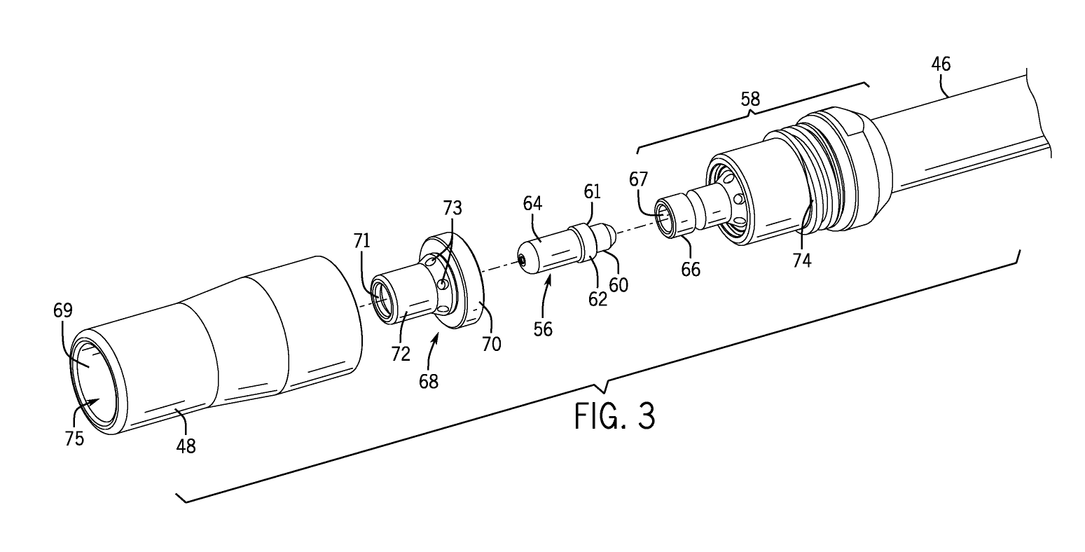

FIG. 3 is an exploded view of a portion of the welding torch 16 of FIG. 2. Included in this illustration is a gas diffuser assembly 58. The gas diffuser assembly 58 receives the contact tip 56 during replacement of the contact tip 56, facilitates mechanical coupling to the welding torch 16 for the contact tip 56, and facilitates electrical coupling to the power source 12 for the contact tip 56, as discussed in detail below. Additionally, the welding nozzle 48 couples to the welding torch 16 via the gas diffuser assembly 58. The gas diffuser assembly 58 may include threads 74 corresponding to threads on an interior of the welding nozzle 48. The threads 74 of the gas diffuser assembly 58 may facilitate securement of the welding nozzle 48 to the welding torch 16 and around the gas diffuser assembly 58.

The contact tip 56 may include three cylindrical sections of varying diameters. For example, as depicted in FIG. 3, the contact tip 56 includes a first section 60, a second section 62, and a third section 64. In certain embodiments, each of the first, second, and third sections 60, 62, and 64 have generally constant diameters. The first section 60 may include a diameter smaller than the second section 62 and the third section 64. Further, the third section 64 may include a diameter that is smaller than the second section 62. In another embodiment, the diameter of the first section 60 may be approximately equal to the diameter of the third section 64, and the diameters of the first section 60 and the third section 64 may be different from the diameter of the second section 62. For example, the diameters of the first section 60 and the third section 64 may be less than or equal to 2 millimeters larger or smaller than each other. Additionally, the diameter of the second section 62 may be greater than 2 millimeters larger than the diameters of each of the first section 60 and the third section 64. It may be appreciated that the terms different or substantially different may be defined as a first parameter having a value that is approximately 20% different from a value of a second parameter. Additionally, in some instances, different or substantially different may be defined as the first parameter having a value that is approximately 15% different from the value of the second parameter. Likewise, the terms similar, substantially similar, or approximately equal may be defined as a first parameter having a value that is within approximately 5% of a value of a second parameter. Further, in some instances, the terms similar, substantially similar, or approximately equal may be defined as a first parameter having a value that is within approximately 2% of the value of the second parameter.

Additionally, the first section 60, the second section 62, and the third section 64 may be of any other shape that may fit within the gas diffuser assembly 58. For example, the first, second, and third sections 60, 62, and 64 may be square, triangular, hexagonal, conical, bullet shaped, or any other adequate shape. Likewise, the gas diffuser assembly 58 may include a retention orifice 66 that is shaped in a manner to correspond to the shape of one of the first, second, and third sections 60, 62, and 64. Additionally, a diameter of the first, second, and third sections 60, 62, and 64 may be defined to mean an average diameter of whichever shape the diameter is describing. For example, the diameter may be the average diameter of a cylindrical shape, a conical shape, a square shape, a triangular shape, a hexagonal shape, a bullet shape, or any other adequate shape.

Further, it may be appreciated that any suitable combination of diameters of the sections 60, 62, and 64 is contemplated. The diameter of the first section 60 may be a size corresponding to the retention orifice 66 of the gas diffuser assembly 58. For example, the retention orifice 66 may include a diameter that is slightly larger than the diameter of the first section 60, such that the first section 60 is insertable into the retention orifice 66. In some embodiments, the diameter of the first section 60 may be 98% the size of the diameter of the retention orifice 66. Additionally, the diameter of the retention orifice 66 may be smaller than the second section 62 of the contact tip 56, such that a shoulder 61 formed between the first section 60 and the second section 62 prevents further movement of the contact tip 56 into the retention orifice 66 by abutting an outer edge 67 of the retention orifice 66 when the contact tip 56 is installed within the retention orifice 66.

With the contact tip 56 installed within the retention orifice 66, a contact tip retainer assembly 68 may be positioned over the contact tip 56. The third section 64 of the contact tip 56 may protrude through an inner bore 71 of the contact tip retainer assembly 68 when the contact tip retainer assembly 68 is installed over the contact tip 56. Further, in certain embodiments, the contact tip retainer assembly 68 may include an electrically insulating portion 70 and a conductive portion 72. The conductive portion 72 of the contact tip retainer assembly 68 may include the inner bore 71 that is slightly larger than a diameter of the third section 64 of the contact tip 56 and slightly smaller than a diameter of the second section 62 of the contact tip 56. Additionally, the conductive portion 72 may abut a shoulder of the contact tip 56 where the second section 62 and the third section 64 of the contact tip 56 meet.

The conductive portion 72 of the contact tip retainer assembly 68 may include gas through ports 73, which direct shielding gas radially outward from the contact tip 56. The gas through ports 73 allow shielding gas to flow through the contact tip retainer assembly 68 and into an inner volume 75 of the welding nozzle 48. Further, the gas through ports 73 may be positioned about an external circumference of the contact tip retainer assembly 68 in such a manner that the gas through ports 73 are accessible for cleaning while the nozzle 48 is installed on the welding torch 16. In particular, the gas through ports 73 may be positioned in such a manner to be accessible by a reaming blade of an automated nozzle reaming device. Such positioning and accessibility of the gas through ports 73 may improve removal of accumulated weld spatter. Further, the electrically insulating portion 70 and the conductive portion 72 of the contact tip retainer assembly 68 may include at least two varying diameters. For example, the conductive portion 72 may have an outer diameter that is smaller than the electrically insulating portion 70. Additionally, the electrically insulating portion 70 may be permanently affixed to the conductive portion 72, or, in other embodiments, the insulating portion 70 may be removable and replaceable with respect to the conductive portion 72.

Furthermore, the contact tip retainer assembly 68 is not permanently affixed to the welding nozzle 48. For example, the contact tip retainer assembly 68 may be completely independent of the welding nozzle 48. In such an embodiment, the contact tip retainer assembly 68 may move axially in an out of an end of the welding nozzle 48 closest to the diffuser assembly 58. Additionally, the contact tip retainer assembly 68 may be removably secured within the welding nozzle 48. For example, the contact tip retainer assembly 68 may be secured within the welding nozzle 48 via a friction fit, a threaded connection, or any other method that may allow the contact tip retainer assembly 68 to be removably secured within the welding nozzle 48. Further, removal of the removably secured contact tip retainer assembly 68 from the welding nozzle 48 may be accomplished without any damage to the welding nozzle 48.

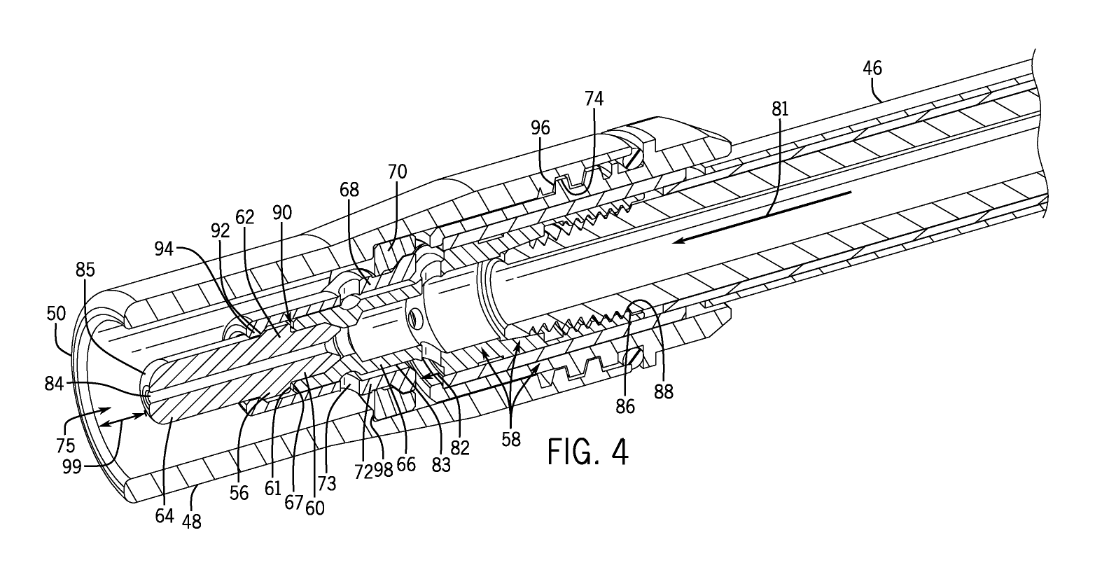

Upon installing the contact tip retainer assembly 68 over the contact tip 56, the welding nozzle 48 may couple to the gas diffuser assembly 58. For example, in the illustrated embodiment, the welding nozzle 48 couples to the gas diffuser assembly 58 by threading the welding nozzle 48 onto the threads 74 on the exterior of the gas diffuser assembly 58. The contact tip 56 and contact tip retainer assembly 68 are axially held in place between the welding nozzle 48 and the gas diffuser assembly 58 of the welding torch 16. In this manner, the contact tip 56, the contact tip retainer assembly 68, and the welding nozzle 48 may all couple to the welding torch 16 in a toolless manner. In particular, an amount of force used to secure the welding nozzle 48 may be approximately 3 to 5 ft·lbs of torque such that a welding operator may thread the welding nozzle 48 to the gas diffuser assembly 58 by hand. As discussed in greater detail below in the discussion related to FIG. 4, the welding nozzle 48 may secure the contact tip retainer assembly 68 and the contact tip 56 to the welding torch 16 by urging the contact tip retainer assembly 68 and the contact tip 56 in a direction toward the neck 46 of the welding torch 16 as the welding nozzle 48 is threaded onto the gas diffuser assembly 58. It may be appreciated that while FIG. 4 illustrates the welding nozzle 48 coupling to the gas diffuser assembly 58 via the threads 74, any other sufficient method of securing the welding nozzle 48 to the gas diffuser assembly 58 may also be used.

The contact tip 56 is removed from the gas diffuser assembly 58 by decoupling the welding nozzle 48 from the gas diffuser assembly 58 and removing the contact tip retainer assembly 68 from over the contact tip 56. Additionally, in some embodiments, the contact tip retainer assembly 68 may be removably secured to the welding nozzle 48, and the contact tip retainer assembly 68 may be removed from the contact tip 56 simultaneously with the welding nozzle 48. After removal of the welding nozzle 48 from the welding torch 16, the contact tip retainer assembly 68 and the contact tip 56 may be removed from the gas diffuser assembly 58 without the aid of tools. Additionally, once the contact tip 56 is removed from the gas diffuser assembly 58, the first section 60 of a new contact tip 56 may be positioned, in an unsecured manner, within the retention orifice 66.

FIG. 4 is a cross-sectional illustration of a portion of the welding torch 16 when the contact tip 56 is in a secured position within the retention orifice 66 of the gas diffuser assembly 58. As illustrated, shielding gas, wire (i.e., the electrode 18), and current flow through the welding torch 16 in an axial direction 81. The shielding gas flows from an inner area of the neck 46 to the gas through ports 73 of the contact tip retainer assembly 68 and toward the end 50 of the welding nozzle 48. The gas through ports 73 may be positioned around the contact tip retainer assembly 68 in such a manner that the shielding gas is directed radially outward into the inner volume 75 of the welding nozzle 48 and toward the interior wall 69 of the welding nozzle 48. The gas diffuser assembly 58 may include pathways to transfer the shielding gas from the neck 46 to the gas through ports 73 of the contact tip retainer assembly 68. For example, the gas diffuser assembly 58 may direct the shielding gas in an axial direction 82 along an external portion 83 of the retention orifice 66, and the contact tip retainer assembly 68 may direct the shielding gas radially outward from the gas through ports 73. As discussed above, the gas through ports 73 may be positioned in such a manner that they are accessible for cleaning while the welding nozzle 48 is coupled to the welding torch 16. Further, the accessibility of the gas through ports 73 may improve removal of accumulated weld spatter.

Additionally, the wire (i.e., the electrode 18) is fed in the axial direction 81 toward the welding location. The wire travels through the gas diffuser assembly 58 and into the contact tip 56. The contact tip 56 includes an elongated body with a hollow interior 84. Further, the hollow interior 84 receives the wire from within the retention orifice 66 and facilitates transmission of the wire in the axial direction 81 toward the welding location.

FIG. 4 also provides an illustration of a path in which the current may flow. For example, a coupling interface 86 couples to the neck 46 of the welding torch 16 to the gas diffuser assembly 58 via mating threaded regions 88 of the neck 46 and the coupling interface 86. Interaction between the threaded regions 88 and the coupling interface 86 enables the flow of current from the neck 46 to the gas diffuser assembly 58. Upon entering the coupling interface 86, the current travels to the retention orifice 66 of the gas diffuser assembly 58. At the retention orifice 66, the current may have multiple transfer paths to the contact tip 56. For example, surface area contact between the contact tip 56 and the retention orifice 66 enables the flow of current into the contact tip 56. Both the contact tip 56 and the retention orifice 66 are made from a conductive material such as brass or copper, which facilitates the current flow.

Additionally, because the contact tip retainer assembly 68 surrounds the contact tip 56, the contact tip 56 is urged into increased and secured surface area contact with the retention orifice 66 by the contact tip retainer assembly 68. In this manner, a contact point 90 between the shoulder 61 of the contact tip 56 and the outer edge 67 of the retention orifice 66 may generate an additional path for current to travel into the contact tip 56. Further, the contact tip 56 may receive the flow of current via the conductive portion 72 of the contact tip retainer assembly 68. For example, there may be contact between the conductive portion 72 of the contact tip retainer assembly 68 and the outer portion 83 of the retention orifice 66 and any additional conductive portion of the gas diffuser assembly 58. As a shoulder 92 of the second section 62 of the contact tip 56 and a shoulder 94 of the conductive portion 72 of the contact tip retainer assembly 68 produce a contact point with each other while the welding nozzle 48 urges the contact tip retainer assembly 68 toward the neck 46, current may also pass from the shoulder 94 into the contact tip 56. Therefore, the flow of current may travel from the gas diffuser assembly 58 to any portion of the contact tip 56 that is in contact with the gas diffuser assembly 58 or the conductive portion 72 of the contact tip retainer assembly 68. As such, any one path described above, or any combination of the paths, may provide sufficient contact for adequate current transfer.

It may be appreciated that the coupling interface 86 may also enable retrofitting an existing welding torch with the gas diffuser assembly 58, the contact tip 56, the contact tip retainer assembly 68 and/or the welding nozzle 48 disclosed herein. For example, the welding torch 16 may be sold with a traditional contact tip securement mechanism coupled to the neck 46 of the welding torch 16. An operator of the welding torch 16 may replace the traditional contact tip securement mechanism with the gas diffuser assembly 58 described in the present disclosure. Accordingly, the operator may purchase the gas diffuser assembly 58, the welding nozzle 48, the contact tip retainer assembly 68, and the contact tip 56 separately from the welding torch 16.

FIG. 4 also illustrates how the contact tip 56 is secured within the retention orifice 66. As illustrated, the welding nozzle 48 is coupled to the gas diffuser assembly 58 via internal threads 96 of the welding nozzle 48 interacting with external threads 74 of the gas diffuser assembly 58. In the secured position, a shoulder 98 of the welding nozzle 48 interacts with the insulating portion 70 of the contact tip retainer assembly 68 to urge the insulating portion 70 toward the gas diffuser assembly 58. In response, the shoulder 94 of the contact tip retainer assembly 68 urges the contact tip 56 toward the retention orifice 66 until the contact point 90 between the contact tip 56 and the retention orifice 66 is achieved in the secured position. Accordingly, the urging of the welding nozzle 48, the contact tip retainer assembly 68, and the contact tip 56 toward the gas diffuser assembly 58 generates sufficient mechanical and electrical contact between conductive portions of the elements for transfer of welding current to the contact tip 56.

To transition the contact tip 56 to the unsecured position, the welding nozzle 48 may be unscrewed or decoupled from the gas diffuser assembly 58 to remove the welding nozzle 48. Once the welding nozzle 48 is removed from the gas diffuser assembly 58, the contact tip retainer assembly 68 may also be removed from the gas diffuser assembly 58. Additionally, the contact tip retainer assembly 68 may be removably secured to the welding nozzle 48, which enables the welding nozzle 48 and the contact tip retainer assembly 68 to be removed from the gas diffuser assembly 58 simultaneously. Removing the welding nozzle 48 and the contact tip retainer assembly 68 transitions the contact tip 56 to the unsecured position. As discussed above, the contact tip 56 is removable without the use of tools while in the unsecured position.

It is also apparent from FIG. 4 that a consistent tip-recess distance 99 between an end 85 of the contact tip 56 and the end 50 of the welding nozzle 48 is achieved. For example, because there are no threads on the contact tip 56, the tip-recess distance 99 is established by a location of the contact point 90 along a length of the contact tip 56 as well as a length of the second portion 62 and the third portion 64 of the contact tip 56. Therefore, potentially threading the contact tip 56 too much or too little becomes inconsequential to achieving the consistent tip-recess distance 99.

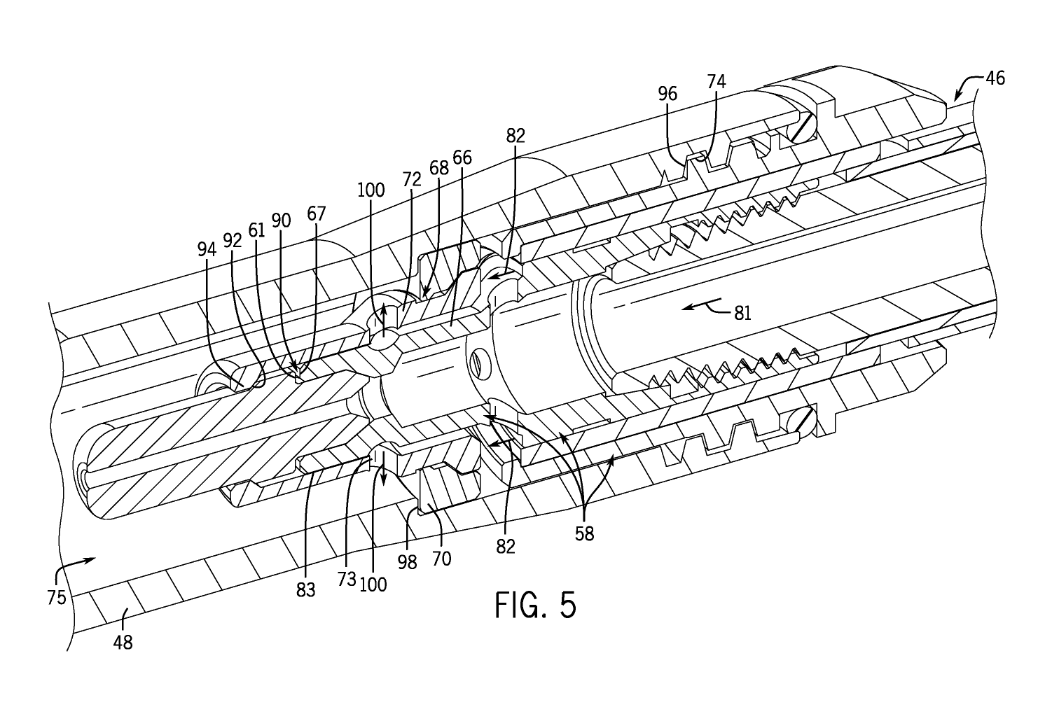

FIG. 5 is a cross-sectional illustration of a magnified portion of the welding torch 16 illustrated in FIG. 4. The magnified portion of the welding torch 16 provides a more detailed view of how the contact tip 56 is secured within the gas diffuser assembly 58. As illustrated, the welding nozzle 48 is coupled to the gas diffuser assembly 58 via the internal threads 96 of the welding nozzle 48 interacting with the external threads 74 of the gas diffuser assembly 58. As the welding nozzle 48 is threaded onto the gas diffuser assembly 58, the shoulder 98 of the welding nozzle 48 interacts with the insulating portion 70 of the contact tip retainer assembly 68 to gradually urge the insulating portion 70 toward the gas diffuser assembly 58. In response, the shoulder 94 of the contact tip retainer assembly 68 gradually urges the shoulder 92 of the contact tip 56 toward the retention orifice 66 until the contact point 90 between the contact tip 56 and the retention orifice 66 is achieved in the secured position. As illustrated, the contact point 90 is achieved when the shoulder 61 of the contact tip 56 interacts with the outer edge 67 of the retention orifice 66. Accordingly, the urging of the contact tip retainer assembly 68 and the contact tip 56 toward the gas diffuser assembly 58 by the welding nozzle 48 generates sufficient mechanical and electrical contact between conductive portions of the elements for transfer of welding current to the contact tip 56.

As discussed above in the discussion of FIG. 4, to transition the contact tip 56 to the unsecured position, the welding nozzle 48 may be unscrewed or decoupled from the gas diffuser assembly 58 to remove the welding nozzle 48. As the welding nozzle 48 is decoupled from the gas diffuser assembly 58, an axial force provided by the contact tip retainer assembly 68 on the contact tip 56 may also be reduced until both the welding nozzle 48 and the contact tip retainer assembly 68 are removable from the gas diffuser assembly 58. Removing the welding nozzle 48 and the contact tip retainer assembly 68 transitions the contact tip 56 to the unsecured position. The contact tip 56 is then removable from the retention orifice 66 without the use of tools while in the unsecured position.

FIG. 5 also provides a detailed view of a flow path of the shielding gas from the neck 46 of the welding torch 16 to the inner volume 75 of the welding nozzle 48. The shielding gas flows from the welding torch 16 through the neck 46 in the axial direction 81. The gas diffuser assembly 58 may direct the shielding gas in an axial direction 82 along an external portion 83 of the retention orifice 66 as the shielding gas flows toward the welding nozzle 48. Once the shielding gas reaches the contact tip retainer assembly 68, the contact tip retainer assembly 68 directs the shielding gas in a radially outward direction 100 through the gas through ports 73. As discussed above, the gas through ports 73 may be positioned such that they are accessible for cleaning while the welding nozzle 48 is coupled to the welding torch 16. Upon exiting the contact tip retainer assembly 68 in the radially outward direction 100, the shielding gas flows into the inner volume 75 of the welding nozzle 48 and is expelled from the welding nozzle 48 toward the work piece 26.

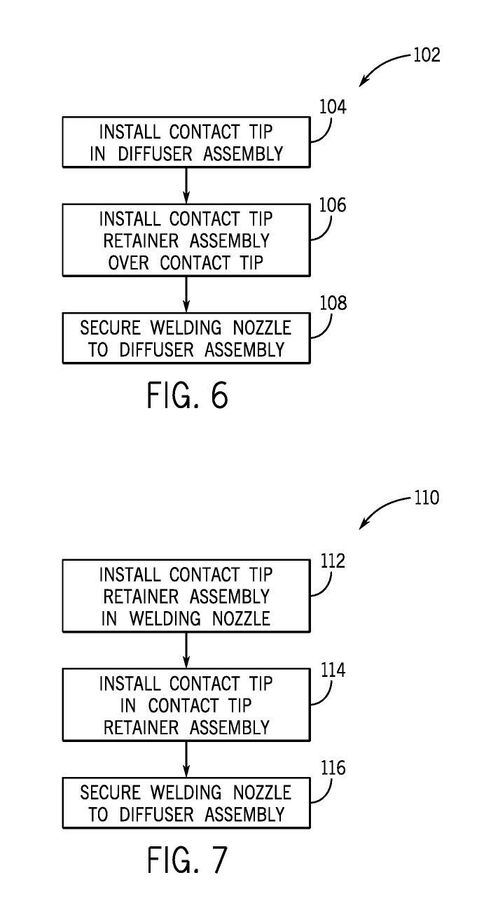

FIG. 6 is a flow diagram of a method 102 for installing the contact tip 56 in the secured position within the gas diffuser assembly 58. Initially, at block 104, the contact tip 56 is installed in the gas diffuser assembly 58. An axial force may be applied on the contact tip 56 in an axial direction toward the neck 46 of the welding torch 16 and into the retention orifice 66. Applying the axial force on the contact tip 56 into the retention orifice 66 may place the contact tip 56 in an unsecured position within the gas diffuser assembly 58. The amount of axial force that establishes the unsecured position of the contact tip 56 within the retention orifice 66 is minimal, and the axial force is achievable without the use of tools.

Subsequently, at block 106, the contact tip retainer assembly 68 is installed over the contact tip 56. The contact tip retainer assembly 68 may be removably secured to the welding nozzle 48. As discussed above, the contact tip retainer assembly 68 includes the inner bore 71 through which the third portion 64 of the contact tip 56 may protrude. Additionally, the contact tip retainer assembly 68 includes the shoulder 94, which acts on the shoulder 92 of the contact tip 56 when the contact tip retainer assembly 68 is urged in an axial direction toward the neck 46 of the welding torch 16. In this manner, the contact tip retainer assembly 68 urges the contact tip 56 toward the neck 46 of the welding torch 16. In urging the contact tip 56 toward the neck 46, the contact tip retainer assembly 68 assists in establishing the secured position of the contact tip 56 within the gas diffuser assembly 58 by minimizing movement of the contact tip 56 while in the secured position.

Further, at block 108, the welding nozzle 48 is secured to the gas diffuser assembly 58. The welding nozzle 48 may be secured to the gas diffuser assembly 58 via the threads 74 of the gas diffuser assembly 58 and the mating threads 96 of the welding nozzle 48. Accordingly, the welding nozzle 48 may be threaded onto the gas diffuser assembly 58 until the welding nozzle 48 reaches the end of the threads 96 of the welding nozzle 48. At this position, the welding nozzle 48 may be secured to the welding torch 16, and a shoulder 98 of the welding nozzle 48 may urge the contact tip retainer assembly 68 toward the neck 46 of the welding torch 16. In turn, the contact tip retainer assembly 68 may urge the contact tip 56 into the retention orifice 66, as discussed above. The contact tip 56 may achieve a secured position within the gas diffuser assembly 58 once the welding nozzle 48 is secured to the gas diffuser assembly 58. Additionally, the welding nozzle 48 may be secured to the gas diffuser assembly 58 without the use of tools. Further, the welding nozzle 48 may be secured to the gas diffuser assembly 58 in any other suitable manner that may similarly urge the contact tip retainer assembly 68 toward the neck 46 of the welding torch 16.

FIG. 7 is a flow diagram of a method 110 for installing the contact tip 56 in the secured position within the gas diffuser assembly 58. Initially, at block 112, the contact tip retainer assembly 68 is installed in the welding nozzle 48. An axial force may be applied to the contact tip retainer assembly 68 into the welding nozzle 48 to initiate a removably secured position within the welding nozzle 48. The removable securement of the contact tip retainer assembly 68 may be accomplished via a friction fit, a threaded connection, or any other method that may allow the contact tip retainer assembly 68 to be removably secured within the welding nozzle 48. Further, the amount of axial force that establishes the removable securement of the contact tip retainer assembly 68 may be achievable without the use of tools.

Subsequently, at block 114, the contact tip 56 is installed in the contact tip retainer assembly 68. An axial force may be applied on the contact tip 56 in an axial direction toward the contact tip retainer assembly 68 and into the inner bore 71 of the contact tip retainer assembly. Applying the axial force on the contact tip 56 into the contact tip retainer assembly 68 establishes an unsecured position of the contact tip 56 within the contact tip retainer assembly 68 and the welding nozzle 48. The amount of axial force that establishes the unsecured position of the contact tip 56 within the contact tip retainer assembly 68 is minimal, and the axial force is achievable without the use of tools.

Further, at block 116, the welding nozzle 48, including the contact tip retainer assembly 68 and the contact tip 56, is secured to the gas diffuser assembly 58. The welding nozzle 48 may be secured to the gas diffuser assembly 58 via the threads 74 of the gas diffuser assembly 58 and the mating threads 96 of the welding nozzle 48. Accordingly, the welding nozzle 48 may be threaded onto the gas diffuser assembly 58 until the welding nozzle 48 reaches the end of the threads 96 of the welding nozzle 48. At this position, the welding nozzle 48 may be secured to the welding torch 16, and a shoulder 98 of the welding nozzle 48 may urge the contact tip retainer assembly 68 toward the neck 46 of the welding torch 16. In turn, the contact tip retainer assembly 68 may urge a portion of the contact tip 56 into the retention orifice 66 of the gas diffuser assembly 58. The contact tip 56 may achieve a secured position within the gas diffuser assembly 58 once the welding nozzle 48 is secured to the gas diffuser assembly 58. Additionally, the welding nozzle 48 may be secured to the gas diffuser assembly 58 without the use of tools. Further, the welding nozzle 48 may be secured to the gas diffuser assembly 58 in any other suitable manner that may similarly urge the contact tip retainer assembly 68 toward the neck 46 of the welding torch 16.

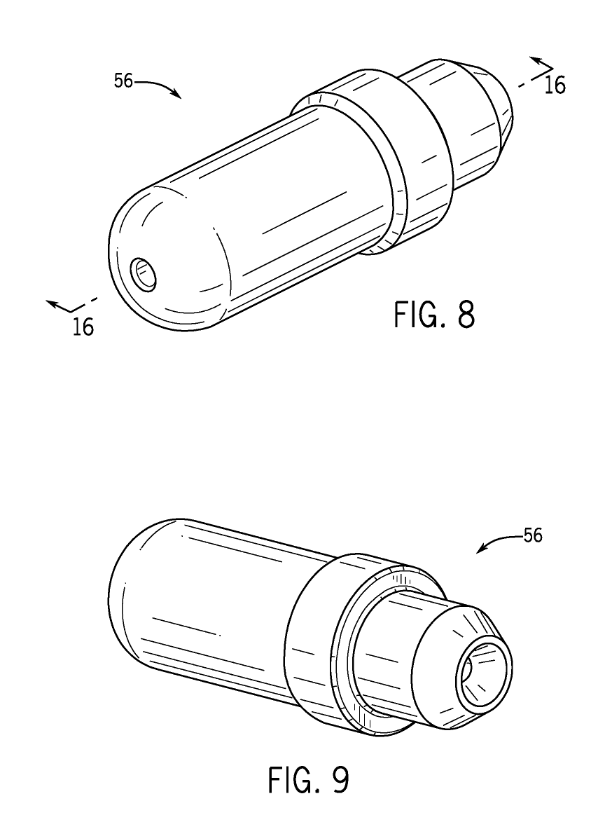

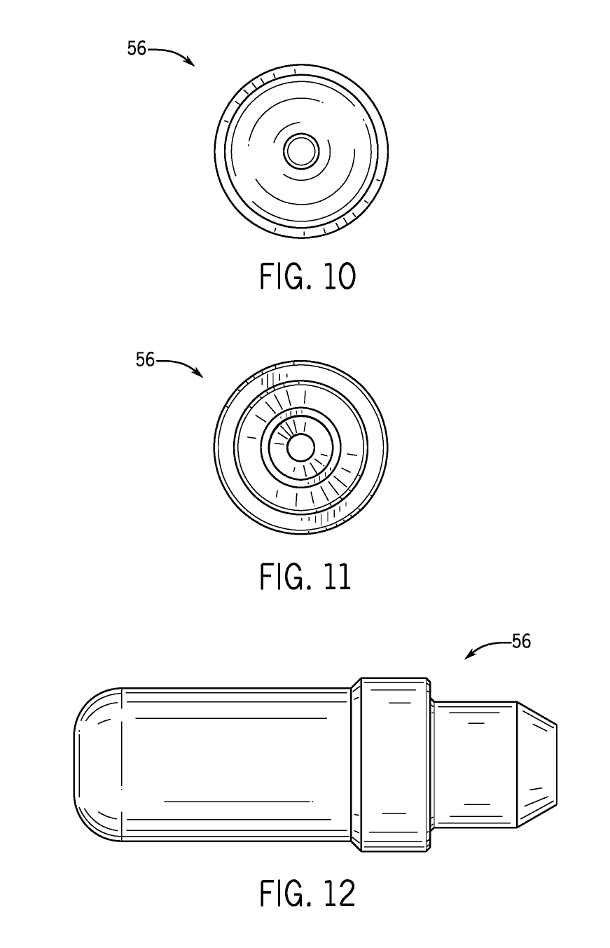

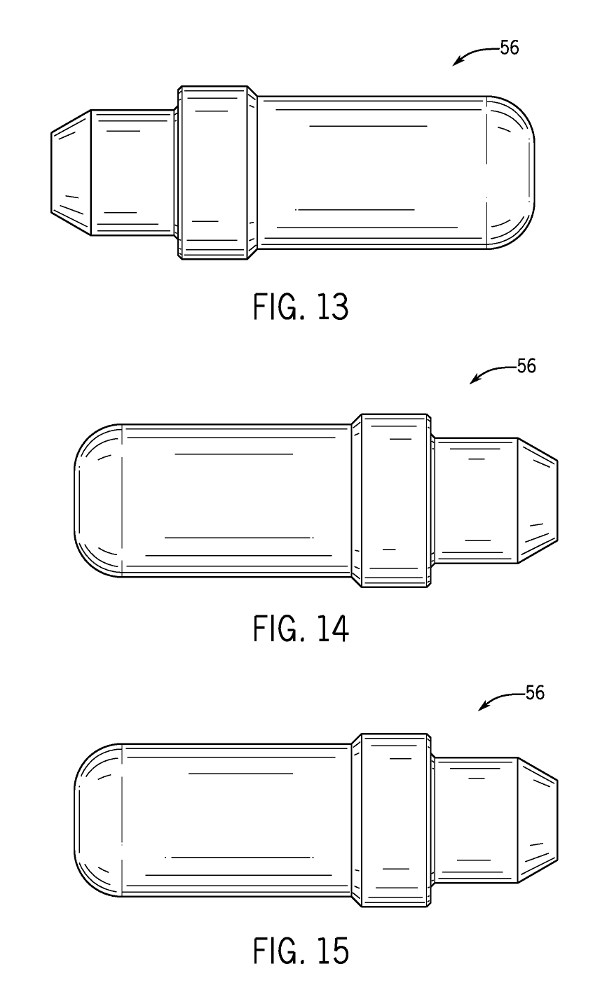

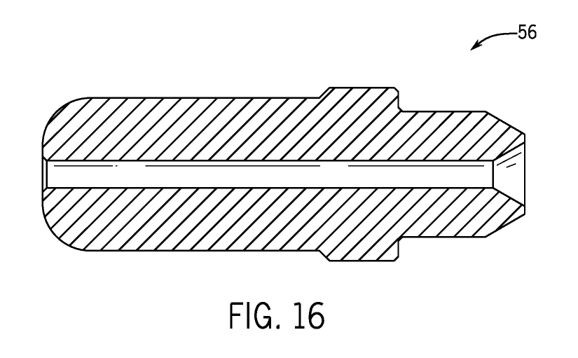

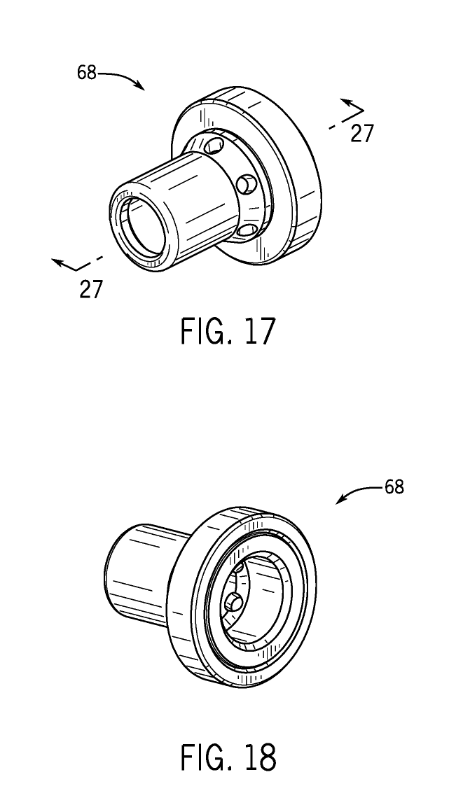

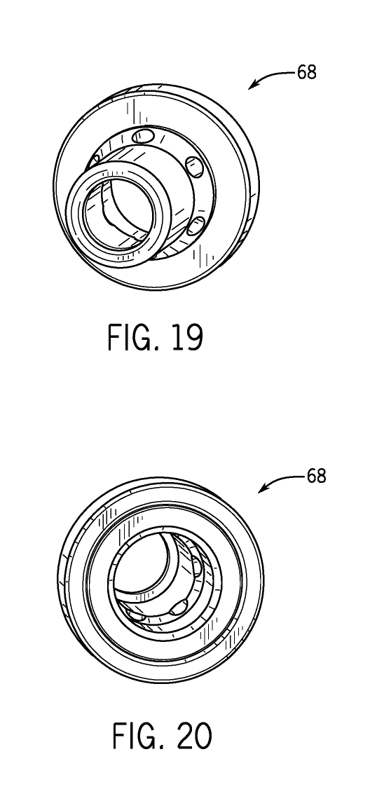

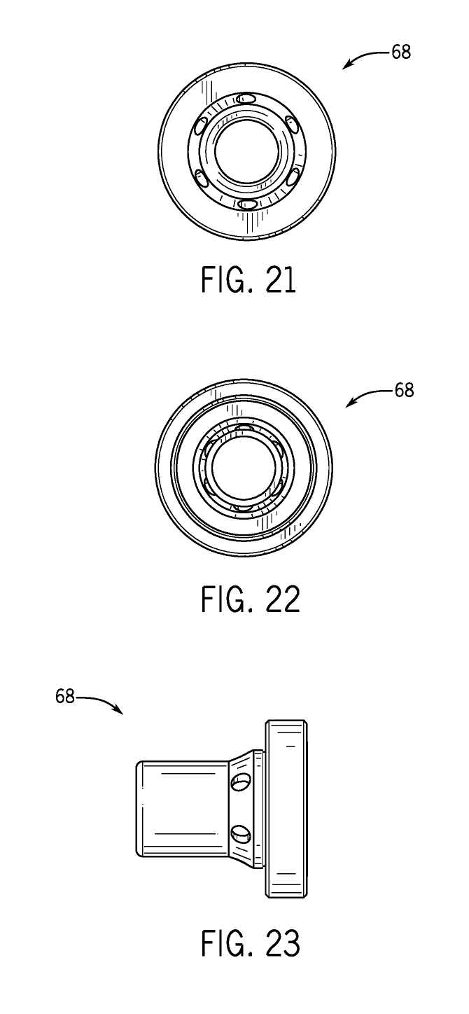

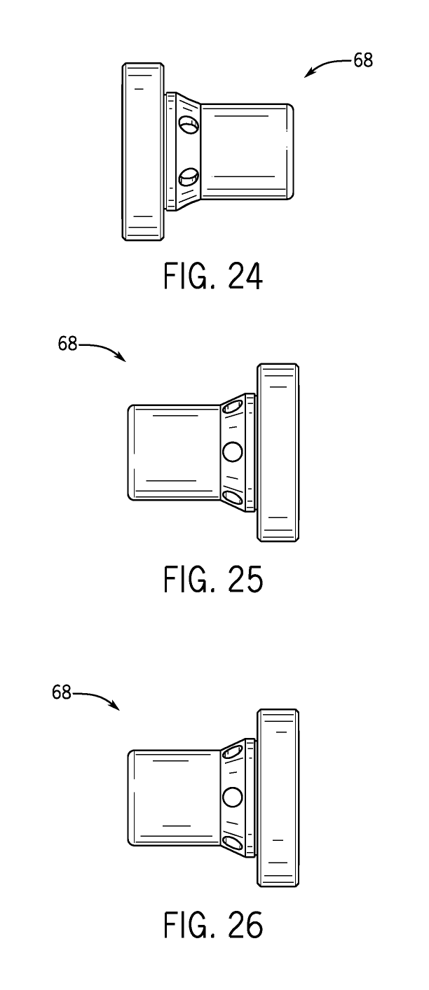

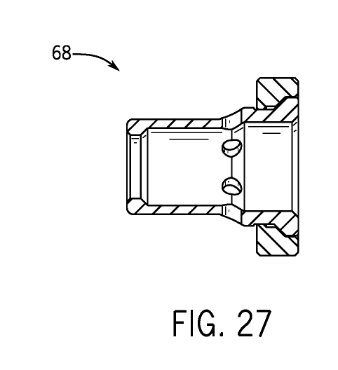

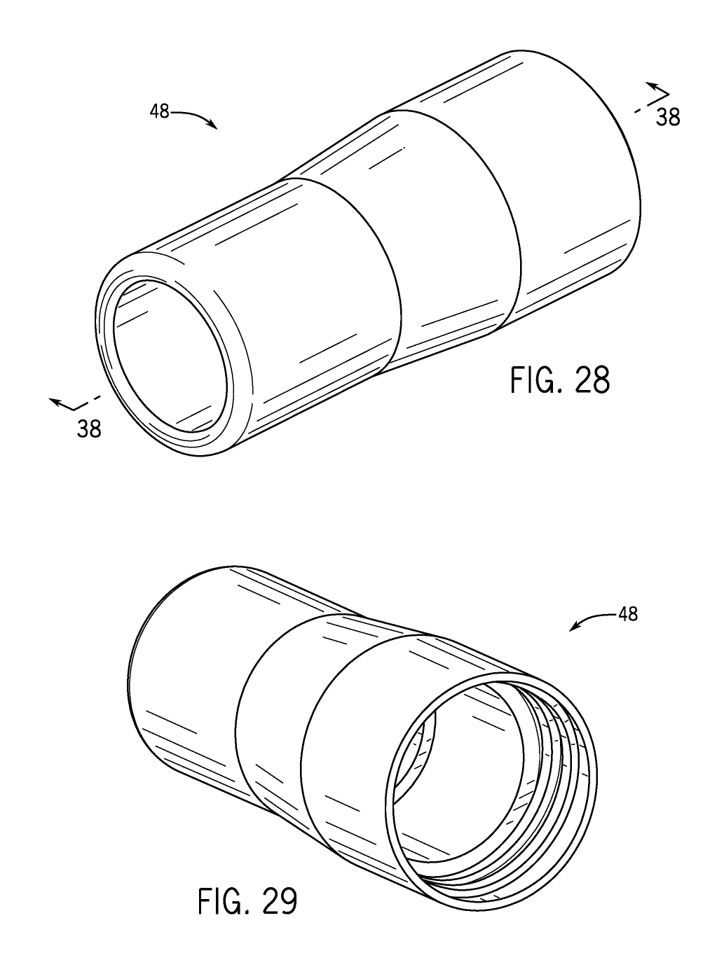

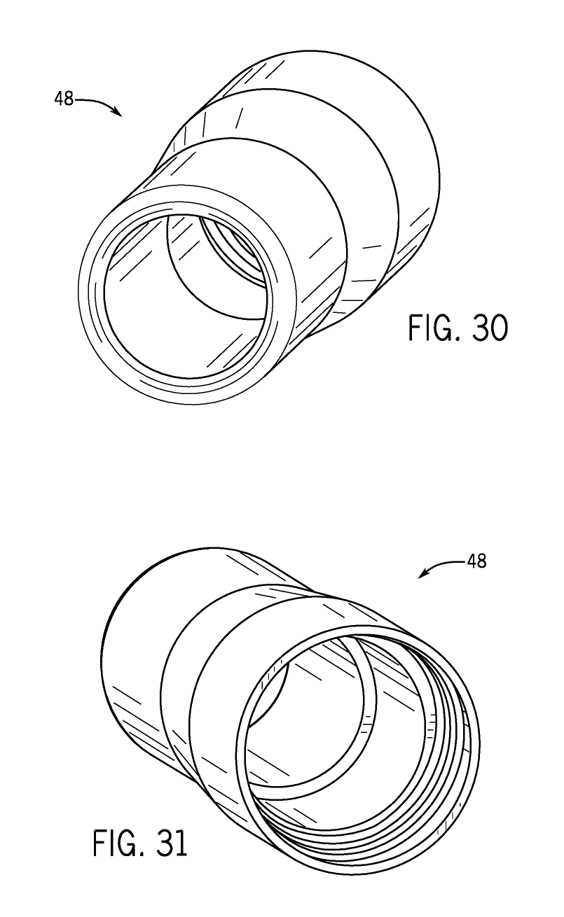

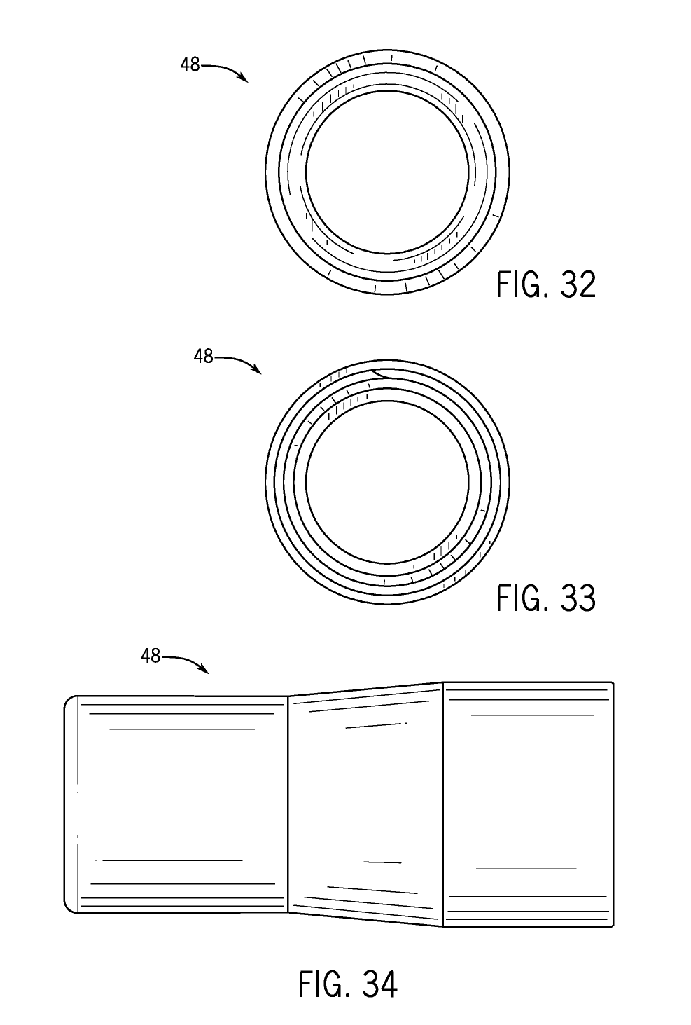

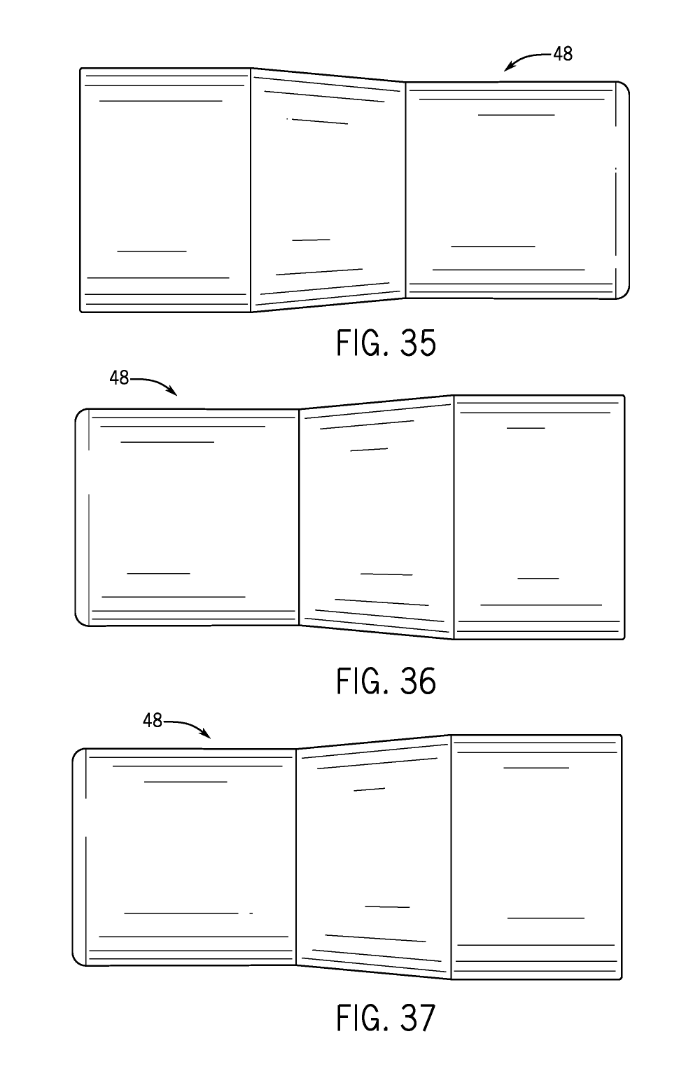

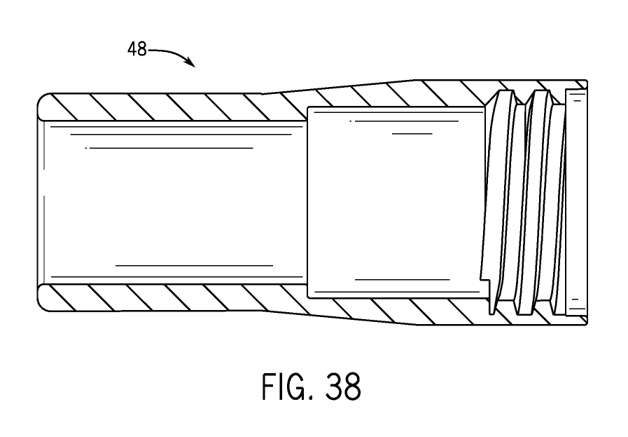

FIGS. 8-16 illustrate various views of a design for the contact tip 56 described herein. FIGS. 17-27 illustrate various views of a design for the contact tip retainer assembly 68 described herein. FIGS. 28-38 illustrate various views of a design for the welding nozzle 48 described herein.

While only certain features of the subject matter have been illustrated and described herein, many modifications and changes will occur to those skilled in the art. It is, therefore, to be understood that the appended claims are intended to cover all such modifications and changes as fall within the true spirit of the disclosure.

1. A welding torch system comprising:
a nozzle;
a contact tip retainer assembly;
a diffuser assembly configured to couple to a neck of a welding torch; and
a contact tip configured to be axially secured between the contact tip retainer assembly and the diffuser assembly, wherein the nozzle axially secures the contact tip retainer assembly and the contact tip to the diffuser assembly.

2. The welding torch system of claim 1, wherein the contact tip is toollessly removable from the diffuser assembly when the contact tip is in an unsecured position within the diffuser assembly.

3. The welding torch system of claim 2, wherein the contact tip is in the unsecured position when the nozzle is decoupled from the diffuser assembly.

4. The welding torch system of claim 1, wherein the contact tip is in a secured position when the nozzle is coupled to the diffuser assembly.

5. The welding torch system of claim 1, wherein the diffuser assembly comprises a retention orifice, and at least a portion of the contact tip is configured to be received in the retention orifice.

6. The welding torch system of claim 1, wherein the contact tip comprises a first portion having a first diameter, a second portion having a second diameter, and a third portion having a third diameter, wherein the second portion is disposed between the first portion and the third portion along an axial length of the contact tip.

7. The welding torch system of claim 6, wherein the first diameter of the first portion, the second diameter of the second portion, and the third diameter of the third portion are different.

8. The welding torch system of claim 6, wherein the first diameter of the first portion and the third diameter of the third portion are approximately equal, and wherein the second diameter of the second portion is different from the first diameter and the third diameter.

9. The welding torch system of claim 1, wherein the contact tip retainer assembly comprises gas through ports configured to direct shielding gas radially outward from the contact tip and into an inner volume of the nozzle when the nozzle axially secures the contact tip retainer assembly and the contact tip to the diffuser assembly.

10. The welding torch system of claim 1, wherein the contact tip retainer assembly is not permanently affixed to the nozzle.

11. The welding torch system of claim 1, wherein the contact tip retainer assembly is removably secured to the nozzle.

12. A welding torch system comprising:
a contact tip assembly, comprising:
a nozzle;
a contact tip retainer assembly;
a diffuser assembly; and
a contact tip axially secured between the contact tip retainer assembly and the diffuser assembly in response to securement of the nozzle relative to the diffuser assembly, wherein the contact tip comprises a first portion, a second portion, and a third portion, and wherein the second portion comprises a second average diameter that is greater than a first average diameter of the first portion and a third average diameter of the third portion.

13. The welding torch system of claim 12, wherein the first average diameter, the second average diameter, and the third average diameter are different from each other, and wherein the second portion is disposed between the first portion and the third portion along an axial length of the contact tip.

14. The welding torch system of claim 12, wherein the first average diameter and the third average diameter are approximately equal, and wherein the second portion is disposed between the first portion and the third portion along an axial length of the contact tip.

15. The welding torch system of claim 12, wherein the nozzle urges the contact tip into a secured position within the diffuser assembly when the nozzle is coupled to the diffuser assembly.

16. The welding torch system of claim 12, wherein the diffuser assembly comprises a retention orifice that is configured to receive at least a portion of the contact tip.

17. The welding torch system of claim 12, wherein the contact tip assembly is configured to retrofit and replace an existing contact tip assembly of the welding torch system.

18. The welding torch system of claim 12, wherein a first shoulder is formed along an axial length of the contact tip at a first location where the first portion and the second portion meet;
wherein a second shoulder is formed along the axial length of the contact tip at a second location where the second portion and the third portion meet; and
wherein the first shoulder is configured to abut the diffuser assembly and the second shoulder is configured to abut the contact tip retainer assembly.

19. A method comprising:
applying a first axial force on a contact tip toward a diffuser assembly of a welding torch to position a first cylindrical portion of the contact tip within the diffuser assembly;
applying a second axial force on a contact tip retainer assembly toward the diffuser assembly of the welding torch such that the contact tip retainer assembly is positioned at least partially radially around the contact tip; and
securing a welding nozzle to the diffuser assembly to establish a secure coupling of the contact tip to the diffuser assembly.

20. The method of claim 19, wherein applying the first axial force on the contact tip toward the diffuser assembly comprises placing the contact tip within a retention orifice of the diffuser assembly in an unsecured position.

21. The method of claim 20, wherein the contact tip is toollessly removable from within the diffuser assembly while the contact tip is in the unsecured position.

22. The method of claim 20, comprising removing the welding nozzle from the diffuser assembly to reestablish the unsecured position of the contact tip within the diffuser assembly.

23. The method of claim 19, wherein the contact tip is not toollessly removable after securing the welding nozzle to the diffuser assembly.
